(19) United States
(12) Patent Application Publication
(10) Pub. No.: US 2022/0214026 A1
(43) Pub. Date: Jul. 7, 2022

(54) SELF-ILLUMINATING MANIPULATION ELEMENT

(71) Applicant: AlphaTheta Corporation, Yokohama-shi, Kanagawa (JP)

(72) Inventors: Yuu Nagata, Yokohama-shi, Kanagawa (JP); Hirokazu Izumi, Yokohama-shi, Kanagawa (JP)

(21) Appl. No.: 17/603,614

(22) PCT Filed: Apr. 16, 2019
(86) PCT No.: PCT/JP2019/016249

§ 371 Date: Oct. 14, 2021

(51) Int. Cl. F21V 11/08; F21V 7/04; H01H 13/02; H01H 13/14

(52) U.S. Cl. CPC F21V 11/08; H01H 13/14; H01H 13/023; F21V 7/04

(57) ABSTRACT

A self-illuminating control element in a form of a pad includes: a light-transmissive control element body in a form of a pad body including an operation surface having an illuminating portion of a predetermined shape as a section, a light receiving surface having a light receiving portion as a section and provided opposite the operation surface, and side surfaces connecting the operation surface and the light receiving surface; a light shielding layer covering the operation surface except for the illuminating portion, the light receiving surface except for the light receiving portion, and the side surfaces; a reflection layer formed between the light shielding layer and the pad body; and a light source for feeding an illumination light toward the light receiving portion.

### TECHNICAL FIELD

The present invention relates to a self-illuminating control element.

### BACKGROUND ART

A self-illuminating control element, whose operation surface is illuminated, is used as a control element of electronic devices. Such a self-illuminating control element is used as, as well as a control button of electronic devices, a musical pad of an electronic musical instrument and the like.

The self-illuminating control element often includes a control element body made of a light-transmissive material, a surface of the control element body being coated with a light-blocking paint, a part of which is removed to form a picture pattern (see, for instance, Patent Literatures 1 and 2).

In Patent Literature 1, the self-illuminating control element in a form of a button, which is made of a light-transmissive material, passes light from a light source provided at a backside through to a top surface (i.e. to an operation surface) for illumination. The surface of the button is provided all over with a painted light-shielding film, which is partially removed in a predetermined shape to allow the light to penetrate through the part where the light-shielding film is removed, thereby providing a luminous image of a predetermined figure and/or character (see paragraph [0011]). At this time, the color of the transmitted light is determined by a light-transmissive white paint and/or green print layer coated prior to forming the light-shielding film (see paragraph [0012]).

In Patent Literature 2, an operation surface of the self-illuminating control element, which is to be pushed by a user, is in a form of a center button (push button) and configured to be illuminated. The operation surface is painted white to become entirely luminous or painted black over a white paint to become partially luminous at a part of a mark (e.g. character and icon) where the black paint is removed by laser or the like (paragraph [0012]).

As described above, the button itself is made of a light-transmissive material (e.g. resin) in both of Patent Literatures 1 and 2. This is because a predetermined level of strength and elasticity are required in order to accept the pushing operations and the like. Further, the light source is provided independent of the button body because the control element, which is pushed to be moved, is not adapted to have a built-in light source.

### CITATION LIST

### Patent Literature(s)

Patent Literature 1: International Publication WO 2014/106897

Patent Literature 2: JP 2013-134359 A

### SUMMARY OF THE INVENTION

### Problems to be Solved by the Invention

As described above, the typical self-illuminating control element has a light-transmissive body whose surface is provided with a light-shielding film formed by coating or the like, which is partially removed so that the surface becomes luminous in a predetermined shape (e.g. character and icon).

Accordingly, a large amount of the light transmitted from an external light source through the light-transmissive body to the operation surface is sometimes blocked, failing to provide light quantity sufficient for the light emission at the operation surface.

An object of the invention is to provide a self-illuminating control element capable of increasing light quantity transmitted through the operation surface.

### Means for Solving the Problems

A self-illuminating control element includes: a light-transmissive control element body including: an operation surface in which an illuminating portion of a predetermined shape is defined; a light receiving surface being opposite to the operation surface in which a light receiving portion is defined; and side surfaces connecting the operation surface and the light receiving surface; a light shielding layer covering the operation surface except for the illuminating portion, the light receiving surface except for the light receiving portion, and the side surfaces; a reflection layer provided between the light shielding layer and the control element body; and a light source configured to feed an illumination light toward the light receiving portion.

### BRIEF EXPLANATION OF DRAWINGS

FIG. 1 is a perspective view showing an electronic musical instrument according to an exemplary embodiment of the invention.

FIG. 2 is an exploded perspective view showing a musical pad unit according to the exemplary embodiment.

FIG. 3 is a cross-sectional view showing a pad body according to the exemplary embodiment.

FIG. 4 is a plan view showing an operation surface of the pad body according to the exemplary embodiment.

FIG. 5 is a bottom plan view showing a light receiving surface of the pad body according to the exemplary embodiment.

FIG. 6 is a schematic cross-sectional view showing how a reflection layer and a light shielding layer of the exemplary embodiment are arranged.

FIG. 7 is an enlarged cross-sectional view showing structures of the reflection layer and the light shielding layer of the exemplary embodiment.

FIG. 8 is a schematic cross-sectional view showing optical paths of illumination light of the exemplary embodiment.

FIG. 9 is a schematic cross-sectional view showing optical paths of illumination light according to another exemplary embodiment of the invention.

FIG. 10 is a schematic cross-sectional view showing optical paths of illumination light according to still another exemplary embodiment of the invention.

### DESCRIPTION OF EMBODIMENT(S)

An exemplary embodiment of the invention will be described below with reference to attached drawings.

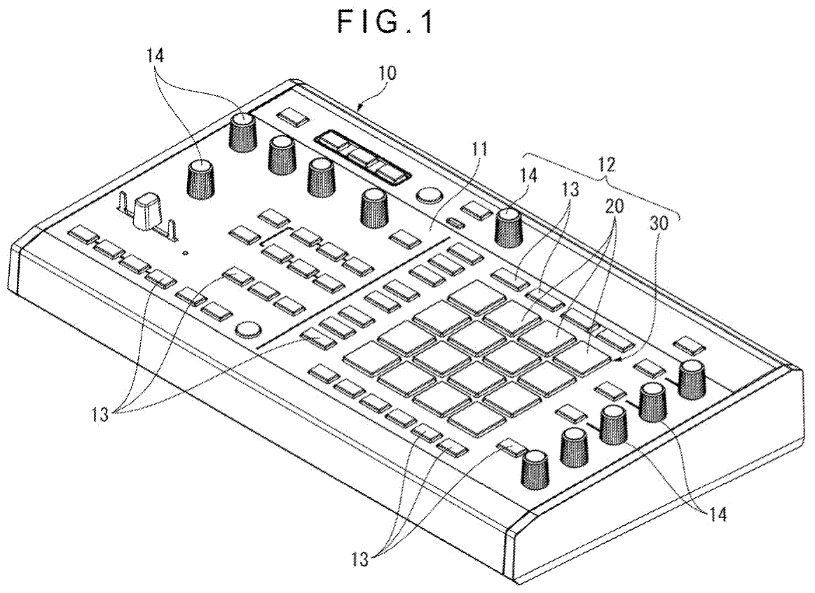

As shown in FIG. 1, an electronic musical instrument 10 includes a control panel 11 and control elements 12 provided on the control panel 11. The control elements 12 are configured to be operated to play pre-stored music and sound effect data and output the data to an external sound system. The control elements 12 include multiple buttons 13 for function selection, knobs 14 for adjusting various parameters, and a musical pad unit 30 including total sixteen block-shaped pads 20 for playing music, which are arranged four vertically and four horizontally.

Various functions (e.g. playing music and sound effect data, effect processing, and changing playing conditions of music pieces currently played) can be assigned in advance to respective pads 20 of the electronic musical instrument 10. During musical performance, these functions can be performed through pushing and keying operations on respective pads 20.

The pads 20 of the musical pad unit 30, which are each a self-illuminating control element according to the invention, are configured to be luminous in a predetermined color(s) in accordance with functions set for respective pads.

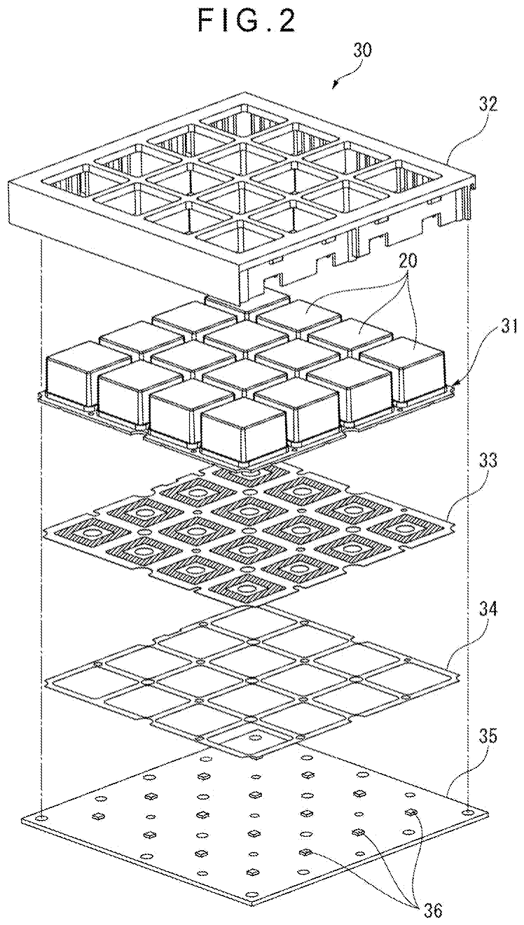

As shown in FIG. 2, the musical pad unit 30 includes a pad molded body 31 (an integrally molded component of the pads 20), a frame 32, a pressure-sensitive sensor 33, a spacer 34, and a board 35.

The pad molded body 31, which is a molded component made of a light-transmissive silicone resin, includes the above-described sixteen pads 20. The pads 20 are each a rectangular block-shaped component.

The frame 32, which is a flat box-shaped component having a top surface provided with openings corresponding to the pads 20, receives the pad molded body 31 from a backside to expose the pads 20 on the top surface, thereby allowing operations on the pads 20 from an outside.

The pressure-sensitive sensor 33 is held together with the spacer 34 between a bottom side of the pad molded body 31 and the board 35.

The pressure-sensitive sensor 33 includes electrodes corresponding to respective pads 20. Each of the electrodes is pressed by a bottom side of the pad molded body 31, thereby enabling to independently detect the pushing operation on corresponding one of the pads 20 from an outside.

The spacer 34 is formed in grids corresponding to the respective pads 20 and is disposed to secure a desired gap between the pressure-sensitive sensor 33 and the board 35 in each grid.

The board 35 is provided with illumination light sources 36 each using a multi-color LED element at the center of each of sections corresponding to the respective pads 20.

When the light source 36 emits light, the illumination light is guided to the bottom side of the pad molded body 31 through corresponding one of the grids of the spacer 34 and corresponding one of through holes in the pressure-sensitive sensor 33 to illuminate corresponding one of the pads 20 from a bottom side thereof.

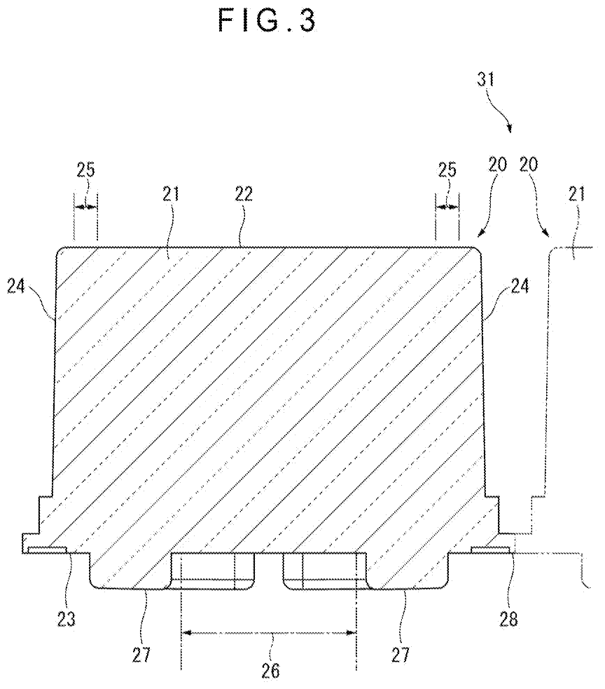

As shown in FIG. 3, the pads 20 each include a rectangular block-shaped pad body 21 made of a silicone resin.

The pad body 21 includes an operation surface 22 and a light receiving surface 23 on a top side and a bottom side opposite the top side, respectively, as well as four side surfaces 24 connecting the operation surface 22 and the light receiving surface 23.

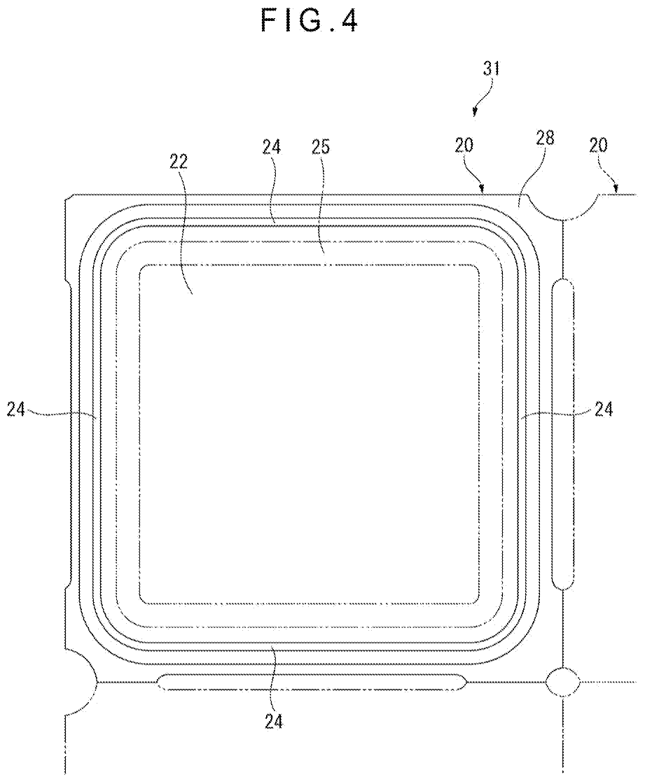

As shown in FIG. 4, on the operation surface 22, an illuminating portion 25 for luminescent display of a predetermined picture pattern on the top side of the pad 20 is defined. In the present exemplary embodiment, the illuminating portion 25 is in a form of a band of a predetermined width that defines a rectangular frame-shaped area continuous along an outer periphery of the operation surface 22.

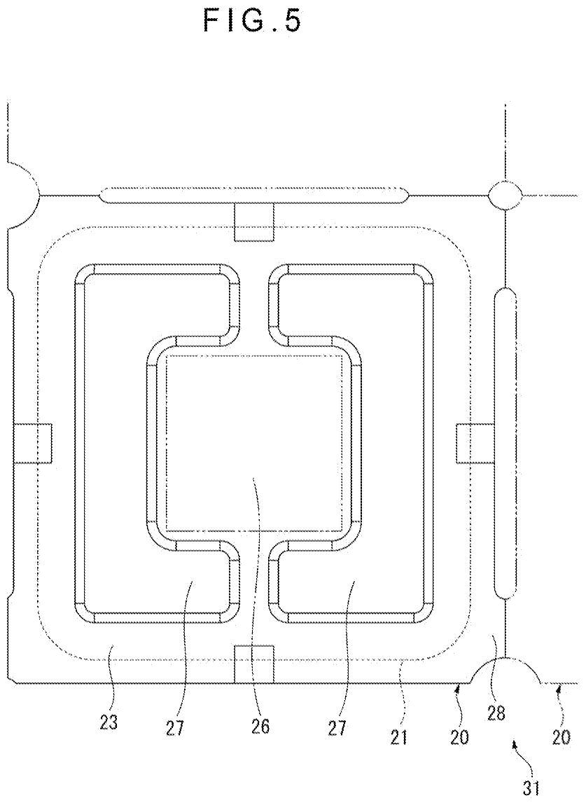

As shown in FIG. 5, on the light receiving surface 23, a light receiving portion 26 for receiving the illumination light from the light source 36 into the pad body 21 is defined, and a pair of transmitting portions 27 formed across the light receiving portion 26 are formed. In the present exemplary embodiment, the light receiving portion 26 is in a form of a rectangular area defined at the center of the light receiving surface 23. The pair of transmitting portions 27, each of which is a substantially C-shaped projection rising from the light receiving surface 23, are formed in a face-to-face manner to surround the light receiving portion 26.

A plurality of (sixteen in total) pads 20 are two-dimensionally connected at bottom bases 28 thereof to form an integrally molded component (i.e. the pad molded body 31).

Each pad 20 also includes a reflection layer 41 and a light shielding layer 42 that are double-layered on the surface of the pad body 21.

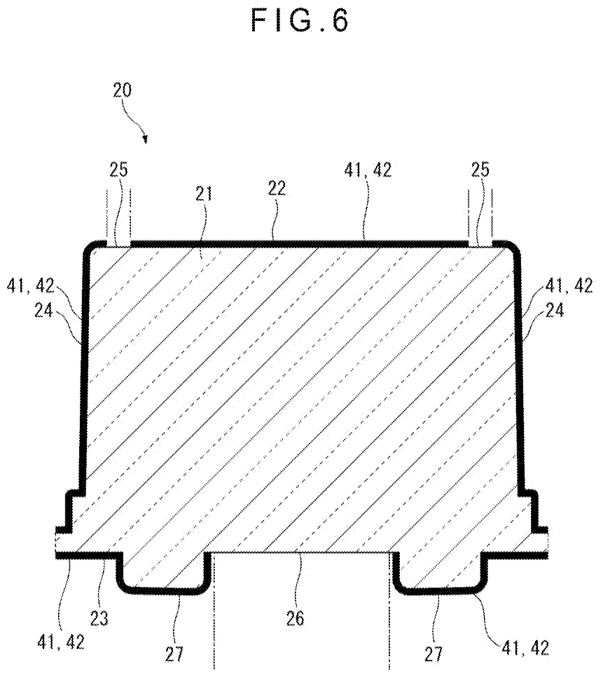

As shown in FIG. 6, the double-layered reflection layer 41 and light shielding layer 42 almost entirely cover the surface of the pad body 21, namely, almost the entirety of the operation surface 22, a part of the light receiving surface 23 including the transmitting portions 27, and the side surfaces 24.

It should however be noted that the reflection layer 41 and the light shielding layer 42 are not formed on the section defining the illuminating portion 25 on the operation surface 22 and the section defining the light receiving portion 26 on the light receiving surface 23, so that the pad body 21 is exposed at the illuminating portion 25 and the light receiving portions 26.

The thus double-layered reflection layer 41 and light shielding layer 42 are each formed by applying a paint on the pad body 21. In the present exemplary embodiment, the reflection layer 41 and the light shielding layer 42 are formed using a white paint and a black paint, respectively.

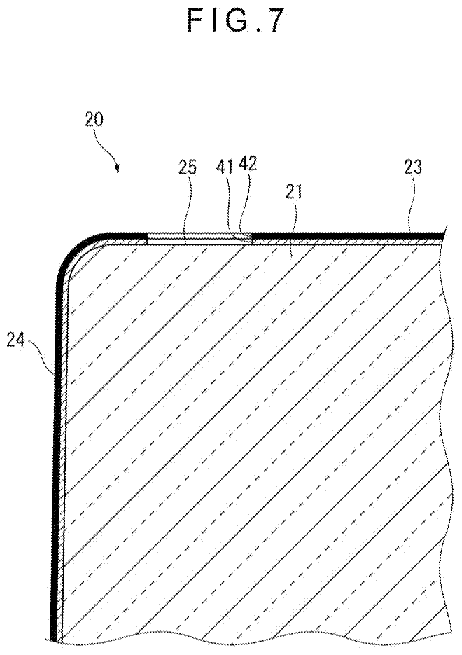

As shown in FIG. 7, the operation surface 22 (except for the section defining the illuminating portion 25) and the side surfaces 24 of the pad body 21 are provided with the double-layered reflection layer 41 and light shielding layer 42.

In order to form the reflection layer 41 and the light shielding layer 42, the white paint is initially applied on the surface of the pad body 21 and is dried to form the reflection layer 41. Subsequently, the black paint is applied on the surface of the reflection layer 41 and is dried to form the light shielding layer 42.

These paints are uniformly applied on the entirety of the operation surface 22 (including the section of the illuminating portion 25) and the side surfaces 24. These paints are optionally applied for a plurality of times.

Subsequently, the reflection layer 41 and the light shielding layer 42 in the section of the illuminating portion 25 are removed. The reflection layer 41 and the light shielding layer 42 can be removed using, for instance, laser processing, mechanical polishing, and/or a solvent. The pad body 21 is thus exposed at the illuminating portion 25.

The double-layered reflection layer 41 and light shielding layer 42 are also provided on the light receiving surface 23 except for the section of the light receiving portion 26.

The reflection layer 41 and the light shielding layer 42 on the light receiving surface 23 are formed in the same manner as the reflection layer 41 and the light shielding layer 42 on the operation surface 22 described above, where, after the paints are applied to form the reflection layer 41 and the light shielding layer 42, the paints in the section of the light receiving portion 26 are removed to expose the pad body 21 at the light receiving portion 26.

According to the present exemplary embodiment, the following advantages can be achieved.

In the present exemplary embodiment, the pad 20 (the self-illuminating control element) includes the light-transmissive pad body 21 (control element body) having the operation surface 22 defined thereon with the illuminating portion 25 of a predetermined shape, the light receiving surface 23 defining the light receiving portion 26 and provided opposite the operation surface 22, and the side surfaces 24 connecting the operation surface 22 and the light receiving surface 23. Further, the pad 20 includes the light shielding layer 42 covering the operation surface 22 except for the section for the illuminating portion 25, the light receiving surface 23 except for the section for the light receiving portion 26, and the side surfaces 24, the reflection layer 41 formed between the light shielding layer 42 and the pad body 21, and the light source 36 for feeding the illumination light toward the light receiving portion 26.

According to the present exemplary embodiment, the illumination light from the light source 36 brightly illuminates the picture pattern formed by the illuminating portion 25 on the operation surface 22.

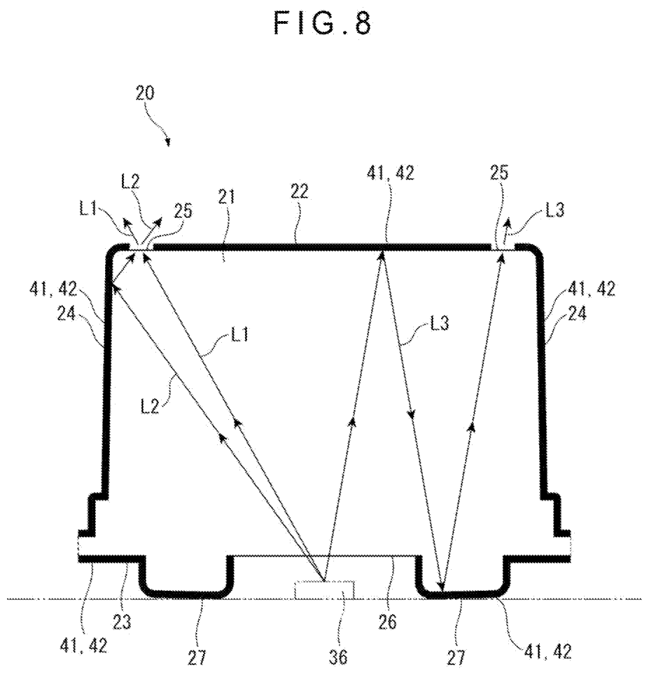

As shown in FIG. 8, the illumination light from the light source 36 enters the pad body 21 through the light receiving portion 26 and is partially outputted through the illuminating portion 25 to an outside (optical path L1). The illumination light cannot go through the area surrounding the illuminating portion 25, since the area is covered with the light shielding layer 42.

Accordingly, the picture pattern formed by the illuminating portion 25 is illuminated on the operation surface 22 against a black background of the light shielding layer 42. Meanwhile, since the side surfaces 24 and a part of the light receiving surface 23 outside the light receiving portion 26 are covered with the light shielding layer 42, the illumination of each of the pads 20 is avoidable from reaching other neighboring pads 20.

In the present exemplary embodiment, the reflection layer 41 is formed between the side surfaces 24 of the pad body 21 and the light shielding layer 42. Accordingly, a part of the illumination light having entered through the light receiving portion 26 is reflected by the reflection layer 41 on the side surfaces 24 to be outputted through the illuminating portion 25 to an outside (optical path L2). Accordingly, brightness of the picture pattern formed by the illuminating portion 25 is higher by an amount of the light through the optical path L2 than brightness of the picture pattern formed by the illuminating portion 25 only with the light through the optical path L1.

Further, in the present exemplary embodiment, the reflection layer 41 between the pad body 21 and the light shielding layer 42 is provided not only on the side surfaces 24 but also on the operation surface 22 and the light receiving surface 23. Accordingly, after entering through the light receiving portion 26 and being reflected by the reflection layer 41 on the operation surface 22, a part of the illumination light is then further reflected by the reflection layer 41 on the light receiving surface 23 and is outputted through the illuminating portion 25 to an outside (optical path L3).

Accordingly, the picture pattern formed by the illuminating portion 25 can be made sufficiently bright by the combined light beams through the optical paths L1, L2, L3.

In the present exemplary embodiment, the reflection layer 41 is formed as a film by applying the paint on the surface of the pad body 21 and the light shielding layer 42 is formed as a film by applying the paint on the surface of the reflection layer 41.

Accordingly, the double-layered reflection layer 41 and light shielding layer 42 can be easily and inexpensively formed.

In the present exemplary embodiment, the reflection layer 41 and the light shielding layer 42 are formed using the white paint and the black paint, respectively.

Accordingly, the reflection layer 41 and the light shielding layer 42, which can be formed without requiring any special paint, can be easily and inexpensively formed.

In the present exemplary embodiment, the pad body 21 is a molded component made of silicone resin.

Accordingly, while providing an appropriate touch feeling of the pad 20, a sufficient pressing force can be transmitted to the pressure-sensitive sensor 33.

In the present exemplary embodiment, the musical pad unit 30 including the multiple pads 20 is configured as a laminate of the board 35 provided thereon with the light source 36, the spacer 34 and the pressure-sensitive sensor 33 provided on the surface of the board 35, and the pad body 21 disposed on the surface of the pressure-sensitive sensor 33.

Accordingly, the push and keying operations on the operation surface 22 of the pad body 21 of each of the pads 20 are detectable by the pressure-sensitive sensor 33 while illuminating the illuminating portion 25 with the illumination light from the light source 36, thereby achieving desired functions of the pads 20 with a simple structure.

Especially, since a transmitting portion 27 configured to be brought into contact with the pressure-sensitive sensor 33 is provided on the light receiving surface 23 of the pad body 21 in the present exemplary embodiment, the detection by the pressure-sensitive sensor 33 can be reliably performed. Further, since the transmitting portion 27 is formed in a pair of substantially C-shaped projections rising from the light receiving surface 23 and surrounding the light receiving portion 26, the transmitting portion 27 can trap the illumination light from the light source 36 to prevent leakage to an outside.

It should be noted that the invention is not limited to the above-described exemplary embodiment but includes modifications and the like as long as such modifications and the like are compatible with an object of the invention.

In the exemplary embodiment illustrated in the above FIGS. 1 to 8, the double-layered reflection layer 41 and light shielding layer 42 are formed on each of the operation surface 22, the light receiving surface 23, and the side surfaces 24, so that the illumination light reaches the illuminating portion 25 through the optical paths L1, L2, L3.

However, the double-layered reflection layer 41 and light shielding layer 42, which are not necessarily formed on all of the operation surface 22, the light receiving surface 23, and the four side surfaces 24 in the invention, are optionally partially omitted.

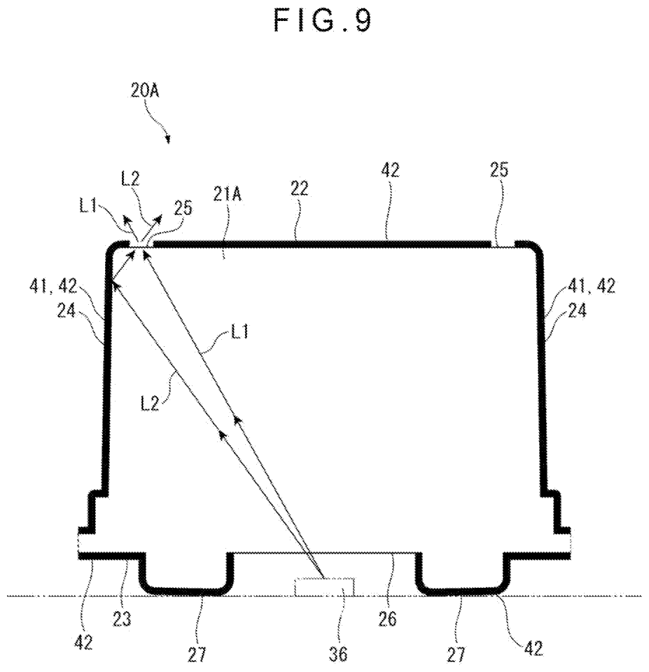

FIG. 9 shows another exemplary embodiment of the invention.

In the present exemplary embodiment, a pad 20A (self-illuminating control element) includes a pad body 21A (control element body).

The pad body 21A includes: the double-layered reflection layer 41 and light shielding layer 42 on the four side surfaces 24; and only the light shielding layer 42 on the operation surface 22 and the light receiving surface 23. The reflection layer 41 is omitted on the operation surface 22 and the light receiving surface 23.

In the exemplary embodiment shown in FIG. 9, in addition to the illumination light through the optical path L1 emitted by the light source 36 to directly reach the illuminating portion 25, the illumination light through the optical path L2 emitted by the light source 36 and reflected by the reflection layer 41 on the side surfaces 24 to reach the illuminating portion 25 can be obtained, so that the illumination of the pad 20A can be more brightened by an amount of the light from the optical path L2.

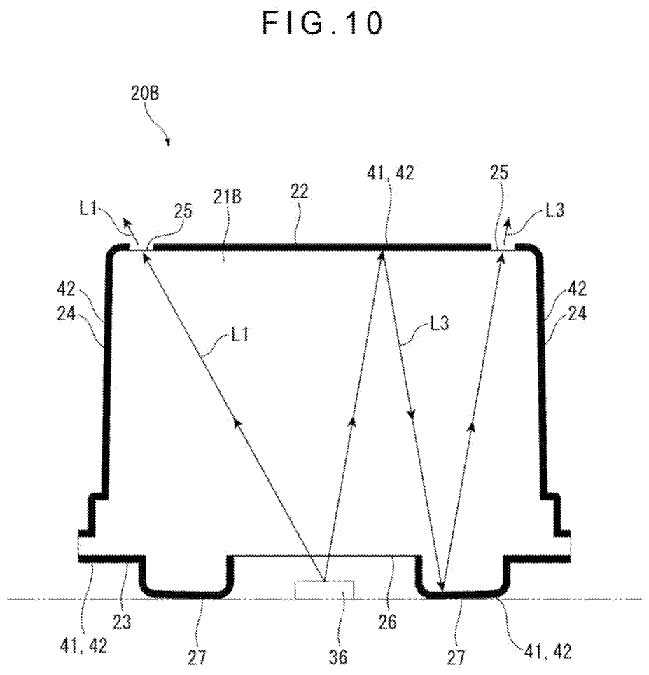

FIG. 10 shows still another exemplary embodiment of the invention.

In the present exemplary embodiment, a pad 20B (self-illuminating control element) includes a pad body 21B (control element body).

The pad body 21B includes: the double-layered reflection layer 41 and light shielding layer 42 on the operation surface 22 and the light receiving surface 23; and only the light shielding layer 42 on the four side surfaces 24. But the reflection layer 41 is omitted on the four side surfaces 24.

In the exemplary embodiment shown in FIG. 10, in addition to the illumination light through the optical path L1 emitted by the light source 36 to directly reach the illuminating portion 25, the illumination light through the optical path L3 emitted by the light source 36 and sequentially reflected by the reflection layer 41 on the operation surface 22 and the reflection layer 41 on the light receiving surface 23 to reach the illuminating portion 25 can be obtained, so that the illumination of the pad 20B can be more brightened by an amount of the light from the optical path L3.

The illuminating portion 25 and the light receiving portion 26 are formed by partially removing the reflection layer 41 and the light shielding layer 42 formed by the paint applied on the surface of the pad body 21 in the above exemplary embodiment. However, the illuminating portion 25 and the light receiving portion 26 are not necessarily formed by removing the reflection layer 41 and the light shielding layer 42. For instance, in some embodiments, after masking is applied in advance on the sections of the illuminating portion 25 and the light receiving portion 26 and then the paints for the double-layered reflection layer 41 and light shielding layer 42 are applied, the masking is removed to expose the surface of the pad body 21. Alternatively, the double-layered reflection layer 41 and light shielding layer 42 are optionally formed only on the surface except for the sections of the illuminating portion 25 and the light receiving portion 26 by coating or other methods.

The reflection layer 41 and the light shielding layer 42 are formed by applying the white paint and the black paint, respectively, on the surface of the pad body 21 in the above exemplary embodiments. But the reflection layer 41 and the light shielding layer 42 are not necessarily formed by applying the black and white paints. For instance, the reflection layer 41 is optionally formed using a light-color paint exhibiting reflectivity or a paint dispersed with a light-reflective material. The light shielding layer 42 is optionally formed using a dark-color paint exhibiting light-blocking property or a paint dispersed with a light-absorbing material.

Further alternatively, the reflection layer 41 and the light shielding layer 42 are optionally formed through other processes (e.g. lamination of a thin film) instead of applying a paint.

The operation surface 22 and the light receiving surface 23 are on the rectangular block-shaped pad body 21 and are opposed in parallel in the above exemplary embodiment. But the operation surface 22 and the light receiving surface 23 are optionally slanted with each other. In addition, the operation surface 22, the light receiving surface 23, and the side surfaces 24 are not necessarily flat surfaces but are optionally each independently a concave or convex curve surface. In any case, it is only necessary that the surfaces are configured so that the illumination light emitted from the light source 36 onto the light receiving portion 26 is reflected by the reflection layer 41 to reach the illuminating portion 25.

The pad body 21 is a molded component of a light-transmissive silicone resin in the above exemplary embodiment. But the pad body 21 is optionally a molded component of other light-transmissive synthetic resin material. Alternatively, the pad body 21 is optionally not molded using a die but is produced by a machining process. The light-transmissive pad body 21 is optionally transparent, translucent, or colored (e.g. milky white), In other words, the pad body 21 is light-transmissive in any manner as long as a desired illumination light can be provided when the light reaches the illuminating portion 25 after passing through the light receiving portion 26 and the pad body 21.

The transmitting portion 27 is provided on the light receiving surface 23 of the pad body 21 in the above exemplary embodiment. But the transmitting portion 27 is not necessarily formed in the same shape as that in the above exemplary embodiment. In addition, the transmitting portion 27 is optionally omitted to directly press the pressure-sensitive sensor 33 with the light receiving surface 23.

In the above exemplary embodiment, the plurality of pads 20 are integrated to form the musical pad unit 30. However, the pad 20 is optionally a single component.

The arrangement of the self-illuminating control element is exemplified by the pad 20 and the musical pad unit 30 for pushing and/or keying operation in the above exemplary embodiment. But the arrangement of the self-illuminating control element is also applicable in order to provide other self-illuminating control elements 12 (e.g. the button 13 and the knob 14) provided to the electronic musical instrument 10. In such an application, the self-illuminating control elements are optionally used in combination with a switch and/or a variable resistor suitable for the specific application instead of the board 35 and the pressure-sensitive sensor 33.

Further, the self-illuminating control element of the invention is also usable not only in the electronic musical instrument 10 but also as a self-illuminating control element in disc jockey instruments (DJ instruments) and sound equipment.

The picture pattern of the illumination of the self-illuminating control element (the picture pattern drawn by light emission of the illuminating portion 25 formed on the operation surface 22) is exemplarily a character, an icon, or a pictogram indicating a function of the control element, if the function is fixed. In contrast, when a plurality of functions are assignable to the control element, in place of the specific icon indicating its function, the illuminated picture pattern is optionally an abstract one such as a frame line extending along the contour of the operation surface 22 (e.g. the rectangular frame-shaped illuminating portion 25 shown in FIG. 4) and a center point indicating the position of the operation surface 22.

### EXPLANATION OF CODES

10 . . . electronic musical instrument, 11 . . . control panel, 12 . . . control elements, 13 . . . button, 14 . . . knob, 20, 20A, 20B . . . pad (self-illuminating control element), 21, 21A, 21B . . . pad body (control element body), 22 . . . operation surface, 23 . . . light receiving surface, 24 . . . side surface, 25 . . . illuminating portion, 26 . . . light receiving portion, 27 . . . transmitting portion, 28 . . . base, 30 . . . musical pad unit (self-illuminating control element), 31 . . . pad molded body, 32 . . . frame, 33 . . . pressure-sensitive sensor, 34 . . . spacer, 35 . . . board, 36 . . . light source, 41 . . . reflection layer, 42 . . . light shielding layer, L1, L2, L3 . . . optical path

1. A self-illuminating control element comprising:
a light-transmissive control element body comprising: an operation surface in which an illuminating portion of a predetermined shape is defined; a light receiving surface being opposite to the operation surface in which a light-receiving portion is defined; and side surfaces connecting the operation surface and the light receiving surface;
a light shielding layer covering the operation surface except for the illuminating portion, the light receiving surface except for the light receiving portion, and the side surfaces;
a reflection layer provided between the light shielding layer and the control element body; and
a light source configured to feed an illumination light toward the light receiving portion.

2. The self-illuminating control element according to claim 1, wherein
the reflection layer is provided between the light shielding layer covering the side surfaces and the control element body.

3. The self-illuminating control element according to claim 1, wherein
the reflection layer is provided between the light shielding layer covering the operation surface and the control element body and between the light shielding layer covering the light receiving surface and the control element body.

4. The self-illuminating control element according to claim 1, wherein
the reflection layer comprises a paint coating applied on a surface of the control element body, and
the light shielding layer comprises a paint coating applied on a surface of the reflection layer.

5. The self-illuminating control element according to claim 4, wherein
the reflection layer is formed by a white paint, and
the light shielding layer is formed by a black paint.

6. The self-illuminating control element according to claim 1, wherein
the control element body is a molded component of a silicone resin.

7. The self-illuminating control element according to claim 1, wherein the self-illuminating control element comprising a laminate of:
a board provided with the light source;
a pressure-sensitive sensor provided on or above a surface of the board; and
the control element body provided on a surface of the pressure-sensitive sensor.

8. The self-illuminating control element according to claim 7, wherein
the control element body comprises on the light receiving surface a transmitting portion configured to be brought into contact with the pressure-sensitive sensor, and
the transmitting portion is formed in an area surrounding the light source.
